(19) United States
(12) Patent Application Publication
(10) Pub. No.: US 2009/0113751 A1
(43) Pub. Date: May 7, 2009

(54) Infrared dryer

(76) Inventors: Shi-Yu Teng, Sanchong City (TW); Chen-Yuan Wang, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,285

(22) Filed: Nov. 1, 2007

(51) Int. Cl. F26B 3/34

(52) U.S. Cl. 34/266

(57) ABSTRACT

An infrared dryer with an infrared dryer body is disclosed. The infrared dryer body includes a cylinder; an infrared light tube, located at substantially central location of the infrared dryer body; an infrared light lampshade, located above the infrared light tube to cover substantially the whole infrared light tube; and at least one shield located above the lampshade inside the cylinder to cover the whole lampshade.

### BACKGROUND OF THE PRESENT INVENTION

1. Field of the Present Invention

The present invention generally relates to an infrared dryer, and particularly to an infrared dryer which provides mixing function as well.

2. Description of the Related Art

Infrared rays are able to convey energy to particles without the use of any media. The energy generates heat to cause molecules to vibrate so that the water inside particles is vaporized to become moistures. Air outside and around the particles is cooler than the moisture inside the particles, and a temperature difference is generated to drive the moisture to leave from the particles. The particles are thereby dried.

The infrared drying is done by means of the temperature difference between the cooler air and the warmer moisture inside the particles. The temperature difference creates pressure gradient which is also a driving force to remove the moisture. Compared to drum blower and vacuum drier which take long to dry with great energy consumption, the infrared dryer offers better drying performance during a shorter period.

As shown in FIG. 1, a conventional infrared dryer 1 has a cylinder 11 and an infrared bracket 12. The cylinder 11 has an entrance 111 and an exit 112. The infrared bracket 12 is located at the position of a shaft of the cylinder 11. A heater 121 is mounted on the infrared bracket 12. At the entrance 111 of the cylinder 11 is mounted a bent-upward feeding tube 13 at a top opening 131 of which has a dispenser 14. The stock particles can be stored in advance in the dispenser 14 and then gradually charged into through the opening 131 of the feeding tube 13. Under the guidance of the feeding tube 13, the particles move forward while the cylinder rotates. Rotating of the cylinder creates agitation of particles, attributing to removal of moisture from the particles and uniform heating to the particles. Furthermore, the infrared rays can reach at deep location of the particles so that moisture there can be removed as well.

For the conventional infrared dryer, it must extend the time period the particles stay inside the cylinder so as to reach a predetermined performance. However, this design has huge volume and will need high production cost.

For the conventional infrared dryer with industrial scale, a great amount of particles has been continuously charged in. If the particles cannot be agitated thoroughly, some of them could be excessively heated and aggregated onto an inner wall of the cylinder 11. As the aggregation become more and more serious, the heating ad drying performance deteriorates and therefore frequent maintenance need.

A plurality of roller 50 is mounted at a bottom of the cylinder 11 to drive the cylinder to rotate. These rollers 50 are connected to one another via a connecting rod 151 and driven by a transmittal device 152. After used for a certain period of time, the rollers 150 at the bottom of the cylinder 11 suffer different levels of wearing and thus have different surface roughness and surface distortion which caused the cylinder to lose its balance during operation. In this case, the particles might be blocked and stop moving forward to the exit 112. Alternatively, the particles accumulate at somewhere inside the cylinder 11, deteriorating the uniform heating of the particles and thus the drying performance.

### SUMMARY OF THE INVENTION

It is one object of the invention to provide an infrared dryer that uniformly dries the stock to be dried.

It is another object of the invention to provide an infrared dryer that prevents any aggregation of stock to be dried.

It is still another object of the invention to provide an infrared dryer that drives a cylinder to firmly rotate while has less need of replacing its transmittal device.

It is another object of the invention to provide an infrared dryer with easy maintenance of infrared light tubes.

It is another object of the invention to provide an infrared dryer that increases the temperature difference between the stock core and the stock surface to improve drying performance.

It is another object of the invention to provide an infrared dryer that prolongs the service life of the infrared light tube, increases mixing efficiency of the drying/dried/un-dried stock particles, and reduce the generation of powders.

In order to achieve the above and other objectives, the infrared dryer of the invention includes an infrared dryer body. The infrared dryer body includes a cylinder; an infrared light tube, located at substantially central location of the infrared dryer body; an infrared light lampshade, located above the infrared light tube to cover substantially the whole infrared light tube; and at least one shield located above the lampshade inside the cylinder to cover the whole lampshade.

In one embodiment of the invention, the infrared dryer further includes a feeding controller located outside the infrared dryer body in a manner to correspond to and connect to the infrared light tube.

In one embodiment of the invention, the infrared dryer includes a feeding device located outside of the infrared dryer body in a manner to connect to the feeding controller.

In one embodiment of the invention, the shield of the infrared dryer has a reversed V profile and a blower.

In one embodiment of the invention, the cylinder of the infrared dryer has a continuous spiral textures and a plurality of tilt guiding plates on its inner wall.

In one embodiment of the invention, the infrared dryer further includes a cage body inside which the cylinder is located, and the lampshade is fixed to the cage body by hooking. A sliding assembly is mounted in a manner to support the feeding controller and the cage body. The feeding controller can be pulled out by means of the sliding assembly for maintenance or replacement of parts.

In another embodiment of the invention, the sliding assembly further includes at least one supporting rod at a bottom of which has a roller. A rail with U-shaped profile is further mounted in parallel to the supporting rod so that the rollers slide along the rail.

In a still another embodiment of the invention, the infrared dryer further includes a transmittal device, a rolling driver and a shaft connecting the transmittal device and the rolling driver. The rolling driver is located under the cylinder in contact with the cylinder.

To provide a further understanding of the present invention, the following detailed description illustrates embodiments and examples of the present invention, this detailed description being provided only for illustration of the present invention.

### BRIEF DESCRIPTION OF THE DRAWINGS

FIG. 1 is a cross-sectional view of a conventional infrared dryer;

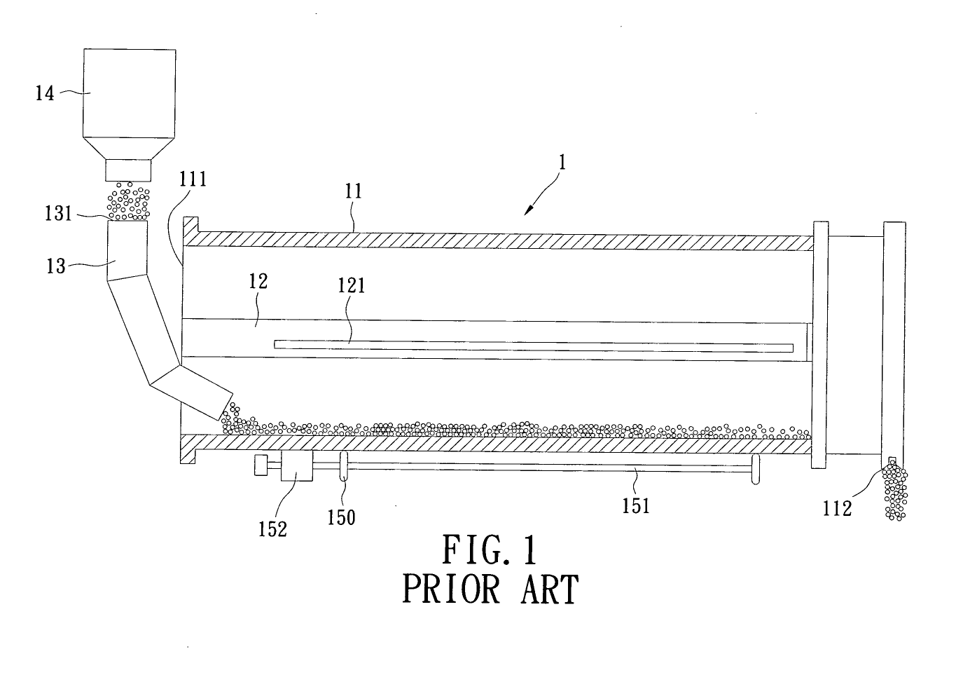

FIG. 2 is a cross-sectional view of an infrared dryer according to one embodiment of the invention;

FIG. 3 is a cross-sectional view of a transmittal an infrared dryer according to one embodiment of the invention;

FIG. 4 is an perspective view showing an interior of an infrared dryer according to one embodiment of the invention; and

FIG. 5 is a cross-sectional view of an infrared dryer combined with a storage device according to one embodiment of the invention.

### DETAILED DESCRIPTION OF THE EMBODIMENTS

Wherever possible in the following description, like reference numerals will refer to like elements and parts unless otherwise illustrated.

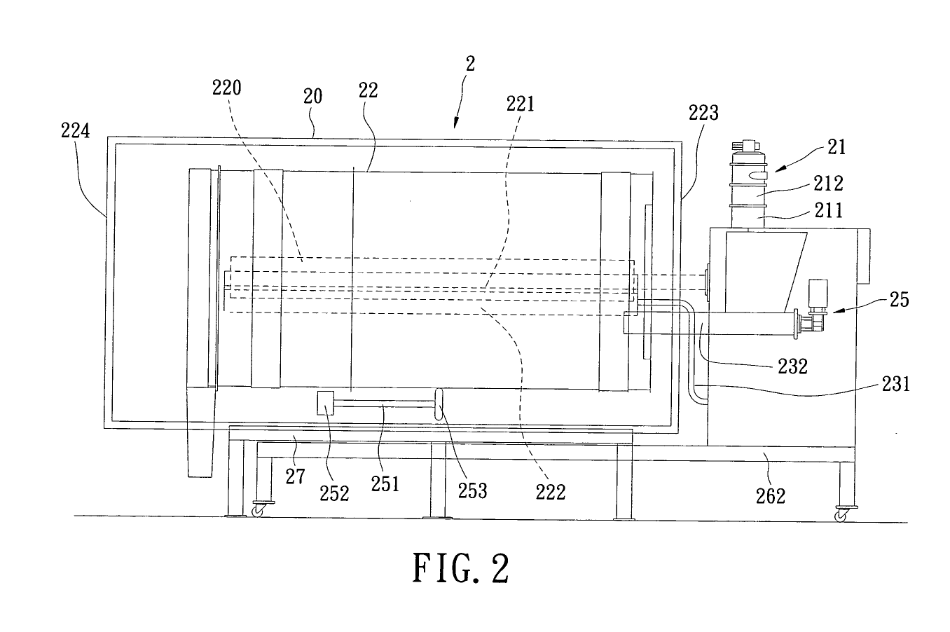

Referring to FIG. 2, an infrared dryer according to one embodiment of the invention includes a feeding device 21, a feeding controller 25, an infrared dryer body 2, a sliding assembly 26 and a holder 27.

The infrared dryer body 2 is preferably of cylindrical shape. At substantially central location of the infrared dryer body 2 are mounted an infrared light tube 221 and an infrared light lampshade 222 covering the whole infrared light tube 221. The infrared light tube 221 is fixed inside the infrared light lampshade 222 an end of which is secured to the feeding controller 25. The feeding device 21 has a stock container 212 and an entrance 211 under the stock container 212. The entrance 211 is connected to the feeding controller 25. The feeding controller 25 controls time period of operating the infrared light tube 221 and the infrared light lampshade 222, the heating temperature, the amount of feeding and the feeding speed, so that dried particles of stock are brought to an optimal or preferable bracket.

The infrared dryer body 2 has a first side 223 and a second side 224. A cage body 20 enclosed by the body 2 has a cylinder 22 therein. The infrared light tube 221 is located substantially at a central position. The lampshade 222 locates around and axially extends along the tube 221.

A shield 220 is mounted above the infrared light lampshade 222, and can be used single or in combination in plurality. No matter one or more shields 220 are used, the shield 220 itself or the combination of a plurality of has a reversed V-shaped or a convex profile which prevents any aggregation of stock particles directly on a surface of the lampshade 222 due to the rotation of the cylinder 22. The shield 220 can made of metal or ceramics which stands the radiation of the infrared light and the drying temperature. The shield 220 at least covers the whole cylinder 22 so as to effectively block the rolling stock particles from falling down onto the lampshade 222 or light tube 221 during operation.

In one embodiment, a blower is optionally mounted on a lower or upper surface of the shield 220, facilitating to uniformly convey the current of air over the particles while the cylinder 22 is rotating. In the embodiment of FIG. 2, the blower is a cooling pipe 231, for example, and connects the feeding controller 25 to the cylinder 22. In addition to convey the current of air over the particles in a desired manner, the blower can be also used to cool down the light tube 221 which is at high temperature after has been used for a while. In an embodiment, the cooling pipe 231 stretches into the cylinder 22 from the first side 223 of the body 2. The lampshade 222 can be fixed to the cage body 20 by hooking.

A holder 27 is mounted at the body 2 to hold the body 2. A sliding assembly 26 is further mounted beneath the feeding controller 25 and the body 2. The sliding assembly 26 has a plurality of supporting rods 262 and a plurality of legs 260 connecting to respective supporting rods 262. Each leg 260 has a roller 261 at its bottom. A rail 28 with U-shaped profile is mounted in parallel to each supporting rod 262 so that the rollers 261 slide along the rails. The rail 28 preferably has the substantially the same length as its supporting rod 262. When the body 2 needs maintenance or replacement of some parts, for example, the light tube 221 is broken or the cylinder 22 needs to be cleaned, it can be easily done by pulling feeding controller 25 out of the body 2 via the sliding assembly 26.

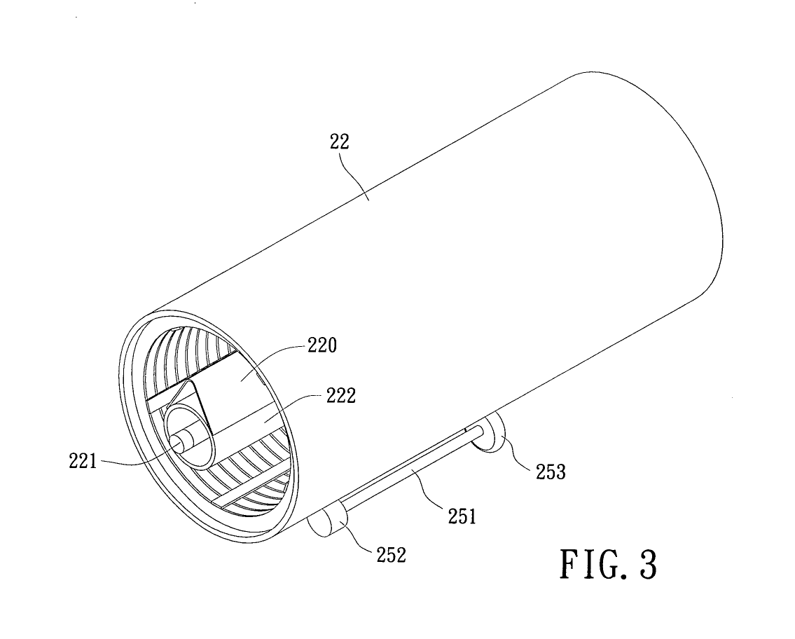

Referring to FIG. 2 and FIG. 3, a rolling driver 253 is mounted in contact with the cage to drive the cylinder 22 to rotate. A transmittal device 252 with a shaft 251 connecting the transmittal device 252 and the rolling driver 253 is used to offer rolling driver 253 the power to be rotated. The transmittal device 252 can be a motor, for example, to transmit the driving force to rolling driver 253 via the shaft 251, and thereby control the rotation speed of the rolling driver 253 and the cylinder 22. The rolling driver 253 is preferably located substantially at the center of gravity of the cylinder 22 to keep the rotation of the cylinder 22 in balance.

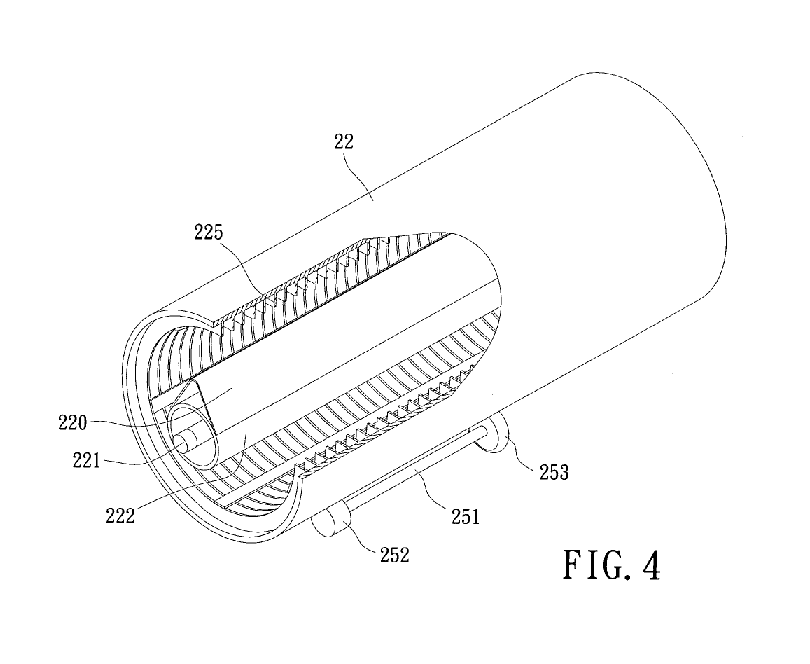

FIG. 4 shows an interior of the cylinder of the infrared dryer. In this embodiment, the shield 220 has a reversed-V shape in cross-section. The cylinder 22 has continuous spiral textures on its inner wall in order to help drive the stock particles to gradually move toward the second side 224 of the body 2 while the cylinder 22 rotates. On the inner wall of the cylinder 22 can be further mounted a plurality of tilt guiding plates 225 which facilitates pushing the stock particles to move forward. The tilt angle of the tilt guiding plate relative to the inner wall is determined by particle size and amount of particles to be dried. The number and distribution of the guiding plate depend on the particle size, the amount of the particles to be dried and the length of the cylinder. With use of the continuous spiral textures and the tilt guiding plate, the stock particles can be thoroughly mixed inside the cylinder 22 and thus uniformly dried. As such, the length of the cylinder can be reduced, and the vaporization on the particles can be accelerated.

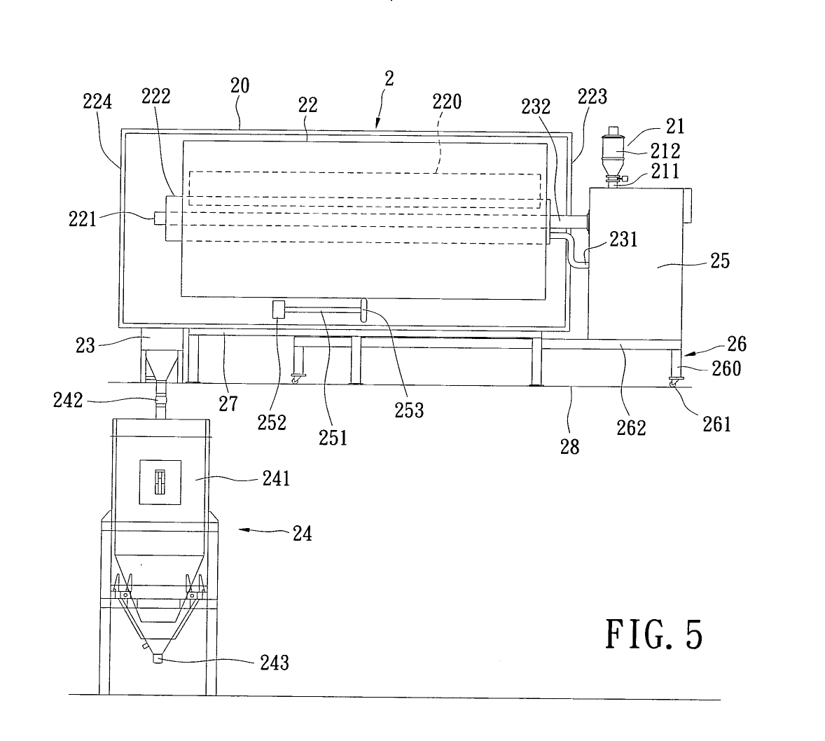

Referring to FIG. 5, the stock particles move toward the second side 224 of the body 2, driven by the rotation of the cylinder 22. Near the bottom of the second side 224 of the cage body 20 are mounted a dried particle exit 23 and a storage device 24 connected to and located above the dried particle exit 23. The storage device 24 is, for example, a storage container 241 with a piping 242 and an outlet 243 at its bottom. The piping 242 is mounted above the container 241 so that the dried stock particles can be transported to the container 241. The outlet 243 outputs the stock particles from the container 241 when in need.

When the stock particles are charged into the body 2 from the entrance 211 to pass through the cylinder 22, the infrared light tube 221 emits infrared lights to dry the stock particles. The sort of stock particles is determined by the wavelength of the infrared rays from the infrared dryer. For short-wavelength infrared rays, it dries polymers such as PET or PLA. While for drying food, it is proper to choose long-wavelength infrared rays according to the inherent properties of the stock.

In light of the above, the infrared dryer according to the invention heats more uniformly the stock to be dried, preventing the stock from being aggregated onto the infrared light tube and reducing the generation of powders while increasing the mixing efficiency of the dried/drying/un-dried stock. Furthermore, the cylinder firmly rotates during operation, with less needs for maintenance and easy of replacing infrared light tube. Therefore, operation cost can be saved. In addition, the infrared dryer according to the invention increases the temperature difference between stock core and stock surface, further attributing to the drying performance.

With the use of the fluid spreader according to the invention, the flow of fluid or TIM between the spreader and a secondary component or components improves such that the force applied to the fluid spreader to promote that fluid flow is substantially reduced in comparison to a fluid spreader or heat transfer structure without channels or protrusions. It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. An infrared dryer, comprising an infrared dryer body which further comprising
a cylinder;
an infrared light tube, located at substantially central location of the infrared dryer body;
an infrared light lampshade, located above the infrared light tube to cover substantially the whole infrared light tube; and
at least one shield located above the lampshade inside the cylinder to cover the whole lampshade.

2. The infrared dryer of claim 1, further comprising a feeding controller located outside the infrared dryer body in a manner to correspond to and connect to the infrared light tube.

3. The infrared dryer of claim 2, further comprising a feeding device located outside of the infrared dryer body in a manner to connect to the feeding controller.

4. The infrared dryer of claim 1, wherein the shield has a reversed V profile.

5. The infrared dryer of claim 1, wherein the shield further has a blower.

6. The infrared dryer of claim 1, wherein the cylinder has a continuous spiral textures on its inner wall.

7. The infrared dryer of claim 1, wherein an inner wall of the cylinder further has a plurality of tilt guiding plates.

8. The infrared dryer of claim 3, further comprising a cage body inside which the cylinder is located, the lampshade is fixed to the cage body by hooking.

9. The infrared dryer of claim 8, further comprising a sliding assembly in a manner to support the feeding controller and the cage body.

10. The infrared dryer of claim 9, wherein the sliding assembly further includes at least one supporting rod at a bottom of which has a roller.

11. The infrared dryer of claim 10, wherein a rail with U-shaped profile is further mounted in parallel to the supporting rod so that the rollers slide along the rail.

12. The infrared dryer of claim 1, further comprising a transmittal device, a rolling driver and a shaft connecting the transmittal device and the rolling driver, wherein the rolling driver is located under the cylinder in contact with the cylinder.

13. The infrared dryer of claim 12, wherein the transmittal device is a motor.

14. The infrared dryer of claim 12, wherein the rolling driver is located substantially at the center of gravity of the cylinder.
